(19) United States
(12) Patent Application Publication
(10) Pub. No.: US 2011/0166411 A1
(43) Pub. Date: Jul. 7, 2011

(54) WARMING THERAPY DEVICE INCLUDING RESUSCITATION CONTROL SYSTEM

(75) Inventors: John H. Richards, Warrington, PA (US); Eugene A. Herben, Nuenen (NL)

(73) Assignee: DRAEGER MEDICAL SYSTEMS, INC., Telford, PA (US)

(21) Appl. No.: 13/062,441

(22) PCT Filed: Sep. 11, 2009
(86) PCT No.: PCT/US09/56650

§ 371 Date: Mar. 4, 2011

Related U.S. Application Data
(60) Provisional application No. 61/098,457, filed on Sep. 19, 2008.
(60) Provisional application No. 61/098,979, filed on Sep. 22, 2008.
(60) Provisional application No. 61/098,969, filed on Sep. 22, 2008.

(51) Int. Cl. A61G 11/00

(52) U.S. Cl. 600/22

(57) ABSTRACT

An apparatus and method for performing warming therapy is described. In one exemplary embodiment, the apparatus includes a patient support assembly (30) and a resuscitation assembly. The resuscitation assembly may include a resuscitation control system (100) with a resuscitation control circuit (110), a light device (150), and a sound device (170), such that the light device (150) may be activated by the resuscitation control circuit (110) to provide a visual indication of inspiration and expiration periods of a resuscitation procedure.

### CROSS REFERENCE TO RELATED APPLICATIONS

This application claims priority to U.S. Provisional Application Ser. No. 61/098,969, filed Sep. 22, 2008, U.S. Provisional Application Ser. No. 61/098,457, filed Sep. 19, 2008, and U.S. Provisional Application Ser. No. 61/098,979, filed Sep. 22, 2008, the entire contents of all of which are hereby incorporated by reference, as if fully set forth herein.

### FIELD OF THE INVENTION

This present invention relates generally to a method and apparatus for performing warming therapy and resuscitation procedures on medical patients. More particularly, the present invention relates to a resuscitation control system which utilizes audio and visual indicators to assist the caregiver in performing resuscitation procedures.

### BACKGROUND OF THE INVENTION

Resuscitation is a vital procedure used in the care of medical patients. Infant patients, in particular, often require resuscitation immediately after birth, or during the first few weeks of life. Since the resuscitation of infant patients is often times more complicated and difficult than the resuscitation of adult patients, the procedures are only typically performed by caregivers of the highest skill level.

Some conventional warming therapy devices (e.g., incubators, warmers, etc.) include means for assisting in the resuscitation of infant patients. Such devices sometimes include resuscitation tubes or hoses for coupling to the infant patient, and sensors for monitoring vital signs important to the resuscitation process. For example, the warming therapy device may include sensors for monitoring pressure and flow parameters such as intrinsic Positive End Expiratory Pressure (PEEP).

Some conventional resuscitation systems (such as ‘breathing bag’ resuscitators or “T-piece” resuscitators) make it difficult for an operator (i.e., caregiver) to maintain the relatively high breath rates and short inspiratory phase times appropriate for resuscitating infants. This is primarily due to conditions such as operator muscle fatigue, and operator inexperience. The inspiratory and expiratory phases of infant resuscitation often require precise control, in accordance with values such as PEEP and Peak Inspiratory Pressure (PIP).

However, conventional resuscitation systems do not include effective means for training or guiding an inexperienced caregiver in infant resuscitation specifically. Moreover, the resuscitation systems included within conventional warming therapy devices also do not include any means for training or guiding an inexperienced caregiver in infant resuscitation.

Accordingly, there is presently a need for a warming therapy device that includes a resuscitation control system for assisting a caregiver in performing resuscitation procedures on infant patients, which allows the caregiver to effectively control the inspiratory and expiratory phases of resuscitation with little or no experience in such procedures.

### SUMMARY OF THE INVENTION

An exemplary embodiment of the present invention comprises an apparatus including a patient support assembly and a resuscitation assembly including a resuscitation control system which includes a resuscitation control circuit, a light device, and a sound device, wherein the light device may be activated by the resuscitation control circuit to provide a visual indication of inspiration and expiration periods of a resuscitation procedure.

An exemplary embodiment of the present invention also comprises an apparatus including a resuscitation control circuit, a light device and a sound device, wherein the resuscitation control circuit receives first and second control signals, and outputs a third control signal for activating or deactivating the light device.

An exemplary embodiment of the present invention also comprises a method of providing resuscitation to a patient, including the steps of performing resuscitation on a patient, observing the condition of a light device during the performance of the resuscitation, performing an inspiration step of the resuscitation when the light device is lit, and performing an expiration step of the resuscitation when the light device is extinguished.

### BRIEF DESCRIPTION OF THE DRAWINGS

FIG. 1 is perspective view of a warming therapy device according to a first exemplary embodiment of the present invention.

FIG. 2 is an overhead perspective view of the warming therapy device of FIG. 1.

FIG. 3 is a block diagram of a resuscitation control system according to a first exemplary embodiment of the present invention.

FIG. 4 is a diagram showing a resuscitation timing signal.

FIG. 5 is a block diagram of a resuscitation control system according to a second exemplary embodiment of the present invention.

FIG. 6 is a block diagram of a resuscitation control system according to a third exemplary embodiment of the present invention.

FIG. 7 is a side elevation view of a resuscitation assembly according to a first exemplary embodiment of the present invention.

FIG. 8 is a perspective view of a hand-held resuscitation device according to a first exemplary embodiment of the present invention.

FIG. 9 is a schematic view of a control system for the hand-held resuscitation device as shown in FIG. 8 and associated resuscitation base station.

### DETAILED DESCRIPTION

The present invention relates to a warming therapy device (e.g., incubator, warmer, etc.) including a resuscitation control system for aiding in the performance of resuscitation. In particular, the warming therapy device includes a resuscitation control system which utilizes audio and visual indicators to assist a caregiver in performing resuscitation procedures.

As noted above, resuscitation is often necessary when caring for infant patients in any infant care setting, such as within a warming therapy device (e.g., incubator, warmer, etc.). However, many conventional resuscitation systems have drawbacks. For example, some conventional resuscitation systems (such as ‘breathing bag’ resuscitators or “T-piece” resuscitators) make it difficult for an operator (i.e., health care worker) to maintain the relatively high breath rates and short inspiratory phase times appropriate for resuscitating infants. This is primarily due to conditions such as operator muscle fatigue and operator inexperience. The inspiratory and expiratory phases of infant resuscitation often require precise control, in accordance with values such as Peak Inspiratory Pressure (PIP), and Positive End Expiratory Pressure (PEEP), as is known to those of ordinary skill in the art. Accordingly, there is presently a need for a device which effectively controls the inspiratory and expiratory phases of resuscitation.

By way of background, warming therapy devices may exist in various configurations, a few of which include ‘closed’ care, ‘open’ care and ‘flexible’ care devices, as explained below. Closed care warming therapy devices (e.g., incubators) provide physical separation between the environment where the infant patient is disposed and the surrounding ambient air. This separation is typically provided by a hood or similar member which encloses the infant patient therein. This encapsulation of the infant patient facilitates creation of conditions favorable for the infant patient's development. Often times, the conditions inside the hood can be significantly different from those present in the ambient environment. Conditions inside the hood may be determined by varying the temperature level, humidity and/or oxygen concentration within the closed care environment, all of which can be controlled automatically using sensors integrated in the warming therapy device. For example, the temperature within the closed care environment may be controlled by sensing the skin temperature of the infant patient and making appropriate adjustments.

Alternatively to closed care warming therapy devices, open care devices (e.g., heaters or warmers) supply heat (through, e.g., overhead infrared radiation) to the infant patient to promote development, and do not typically utilize a hood which separates the infant patient from the surrounding environment. The amount of heat supplied to the infant patient may be fixed, or controlled by one or more skin temperature sensors coupled to the patient, as noted above.

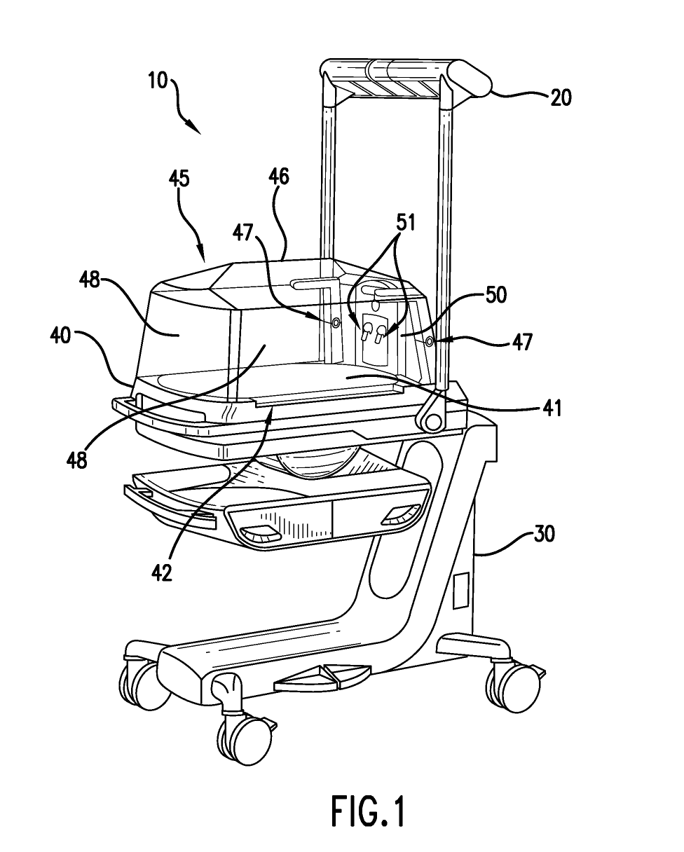

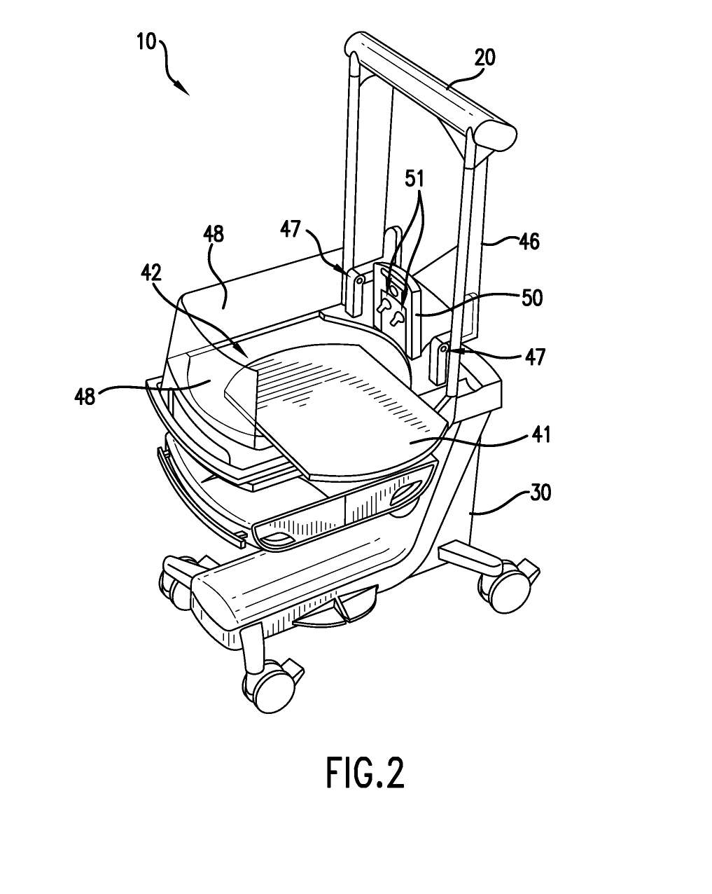

Flexible care warming therapy devices allow both the creation of a separate environment (i.e., inside the hood, when the hood is closed) which can provide humidity, and heating of the infant patient in the warming therapy device (i.e., when the hood is open). Thus, flexible care devices can operate as either ‘open care’ or ‘closed care’ devices. FIGS. 1 and 2, discussed below, show a flexible care warming therapy device according to a first exemplary embodiment of the present invention.

FIGS. 1 and 2 show a warming therapy device 10 according to a first exemplary embodiment of the present invention. The warming therapy device 10 includes a radiant heater head 20, and a patient support assembly 30 including a mattress tray assembly 40. The mattress tray assembly 40 may include a hood 45 which has a top portion 46 which pivots about one or more axes 47. The hood 45 may also include one or more sidewalls 48 which may be slideable, removable, pivotable or rotatable. The mattress tray assembly 40 also preferably includes a mattress tray 42, with a mattress 41 disposed therein. The warming therapy device 10 may optionally include a backplane 50, to which ventilation hoses and other devices may be coupled through, for example, interconnection nozzles 51.

FIG. 2 shows the top portion 46 of the hood 45 rotated up so that it is approximately ninety degrees (90°) with respect to the mattress tray 42. In the exemplary embodiment, the sidewalls 48 of the hood 45 are capable of sliding vertically within a portion of the mattress tray assembly 40, so that they may become disposed, partially or completely, below the plane of the mattress tray 42, or removed completely. In the exemplary embodiment shown in FIG. 2, the front sidewall 48 has been removed to permit movement of the mattress tray 42 in a direction away from the warming therapy device 10.

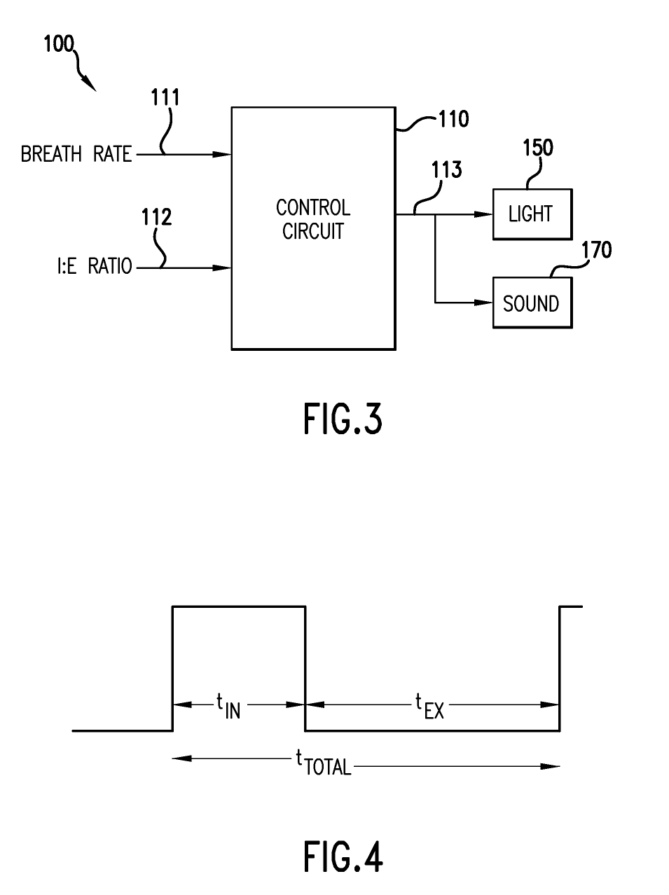

FIG. 3 shows a block diagram of a resuscitation control system 100 according to a first exemplary embodiment of the present invention. In the exemplary embodiment, the resuscitation control system 100 may be formed as part of the warming therapy device 10, or may be formed as a separate unit for use with the warming therapy device 10. For example, the resuscitation control system 100 may be formed as part of a resuscitation assembly, which may also include one or more ventilation hoses and a ventilation mask. As will be understood by those of ordinary skill in the art, the ventilation hoses of such a resuscitation assembly may be coupled to a source of oxygen, ambient air, or an air/oxygen mixture through, for example, interconnection nozzles 51 of the backplane 50 of the warming therapy device 10. Alternatively, the resuscitation control system 100 may be formed as part of a separate resuscitation assembly, also including one or more ventilation hoses and a ventilation mask, which is not directly coupled to a warming therapy device.

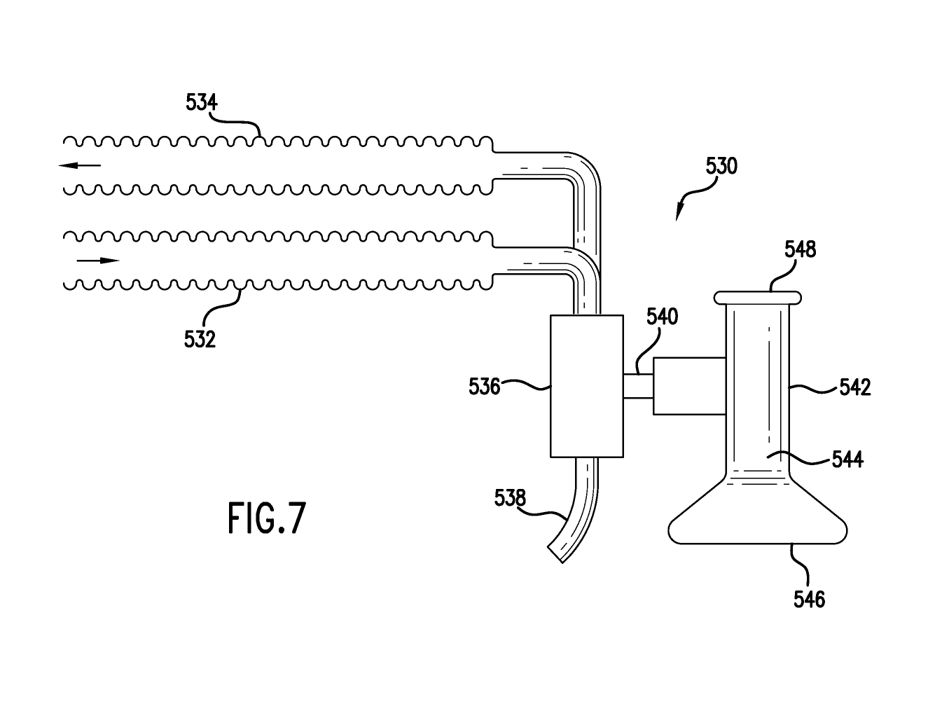

FIG. 7 shows a resuscitation mask 530 according to a first exemplary embodiment of the present invention which may form part of a resuscitation assembly as discussed above. The mask 530, which enables a resuscitation assembly to provide both Continuous Positive Airway Pressure (CPAP) and resuscitation functionality, may be connected to one or more ventilations hoses or lines 532, 534, such as for example, inspiratory and expiratory lines. The ventilation lines 532, 534 may, in turn, be connected at one end to a manifold 536 that has nasal prongs 538 adapted for use on an infant. The other end of the ventilation lines 532, 534 may be coupled to a source of oxygen, ambient air, or an air/oxygen mixture, such as interconnection nozzles 51 of the backplane 50 of the warming therapy device 10. A transfer tube 540 may extend from the manifold 536, and may be adapted to engage a mouthpiece 542. The mouthpiece 542 may have a generally tubular body section 544 that extends between a frustoconical mouth cover 546 and a discharge port 548. The manifold 536 and mouthpiece 542 may include internal passageways (not shown) for providing gas flow to a patient. For example, the manifold 536 may include an internal plenum (not shown) that is connected to both ventilation lines 532, 534. The plenum may operate to join the ventilation lines 532, 534 with a nasal passageway (not shown) extending through each of the nasal prongs 538. Similarly, the transfer tube 540 may include a transfer passageway (not shown) disposed therein that may be coupled to the plenum. A transfer valve (not shown) may also be located within the transfer passageway, such that when the resuscitation mask 530 is used without the mouthpiece 542, the transfer valve is closed, and pressure is maintained within the plenum. The transfer valve may comprise a “duck bill” type valve, or any other equivalent valve known to those of ordinary skill in the art. Although the resuscitation mask 530 is described above as being connected to ventilation lines 532, 534, those of ordinary skill in the art will realize that the resuscitation mask 530 may be connected to a single ventilation line (e.g., ventilation line 532). Such a single ventilation line may provide inspiratory gas only, with the expiratory gas being handled by a valve system (not shown) disposed within either the manifold 536, or the mouthpiece 542. Such a valve system may be controlled manually or electronically, such as through a control system.

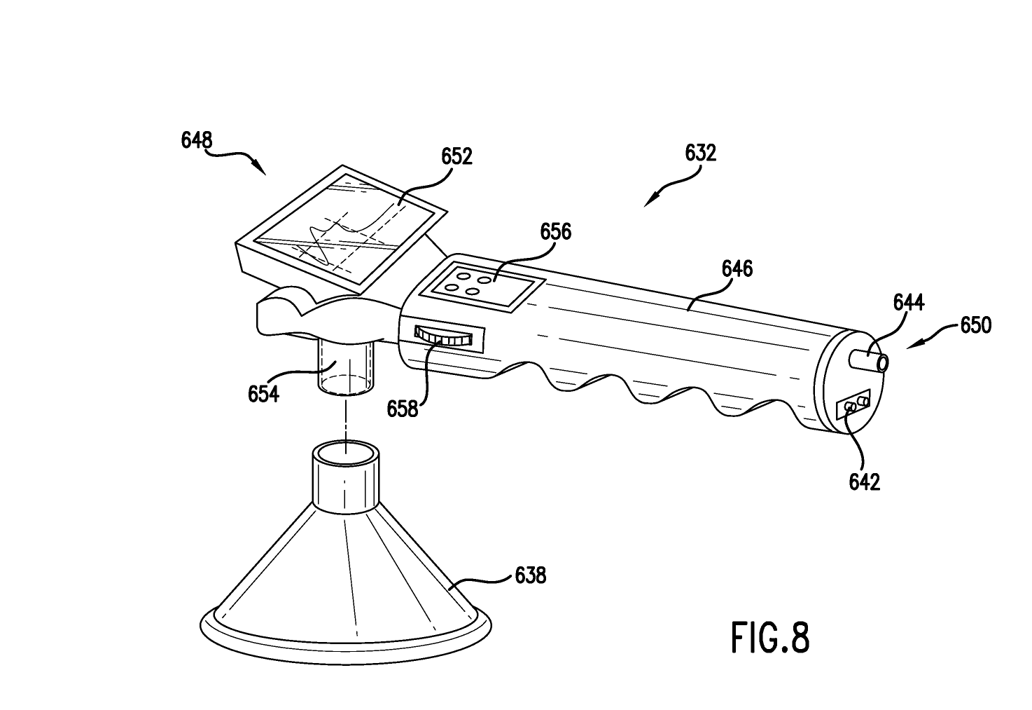

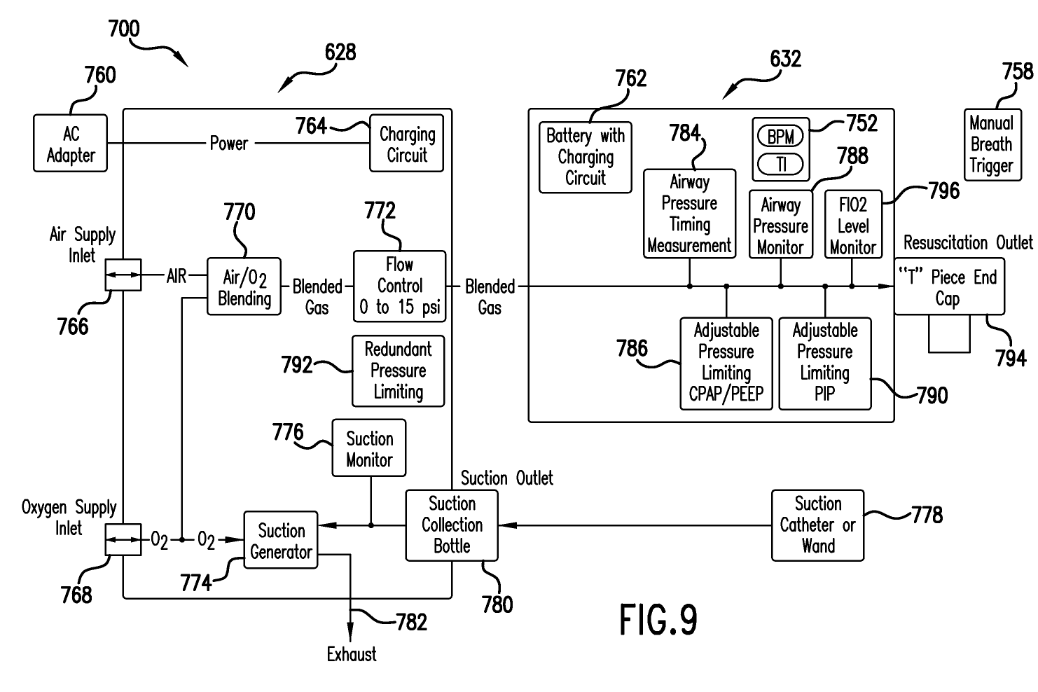

FIG. 8 shows a hand-held resuscitation device 632 according to a first exemplary embodiment of the present invention which may form part of a resuscitation assembly as discussed above. The resuscitation device 632 is adapted to be held in one hand by an attendant or physician, with an ergonomic handle 646 having forward and rear ends 648, 650. The ergonomic handle 646 may be balanced to reduce user fatigue during operation and reduce stress on the infant's airway. Further, the ergonomic handle 646 may be shaped to give a physician or attendant a similar feel to traditional ‘bag-type’ resuscitators. A charging port 642 and a breathing gas port 644 may be disposed at the rear end 650 of the resuscitation device 632. The breathing gas port 644 may be adapted to be connected to one or more ventilation lines at a first end thereof, such as ventilations lines 532, 534, described above with reference to FIG. 7. The other end of the ventilation lines 532, 534 may be coupled to a source of oxygen, ambient air, or an air/oxygen mixture, such as interconnection nozzles 51 of the backplane 50 of the warming therapy device 10. The charging port 642 may have contacts for engagement with a resuscitation base unit 628 (shown in FIG. 9) to charge the resuscitation device 632 when the device is docked therein. The device 632 may also include a breathing port 654 which is adapted for connection to a mouth and nose piece 638. The device 632 may also include a display screen 652 for displaying critical data related to the resuscitation process (e.g., PIP and PEEP values). Placement of the display screen 652 on the resuscitation device 632 allows a user to view critical data without having to turn away from the infant. Additionally, the device 632 may include a control pad 656 which may be used to control parameters such as pressure, timing, oxygen level, flow rate and inspiratory time. Finally, the device 632 may include a manual breath trigger 658, which may provide for the commencement of an automatically-timed breathing cycle when depressed. The breathing cycle may be continuously repeating, or a single breath, depending on preference.

FIG. 9 is a schematic view of control system 700 for the hand-held resuscitation device 632 discussed above, and an associated resuscitation base station 628. The resuscitation base unit 628 may be plugged into a traditional Alternating Current (AC) power source using an AC adapter 760, which converts the AC power to Direct Current (DC) power for powering the resuscitation base unit 628 and charging the resuscitation device 632. The resuscitation device 632 may have a battery circuit 762, which may be electrically connected to the charger port 642 of the device. As discussed above, the charger port 642, may be adapted for mating with a charging circuit 764, located on the resuscitation base unit 628, for charging the resuscitation device 632. The resuscitation base unit 628 may be fed air and oxygen through an air supply inlet 766 and an oxygen supply inlet 768, respectively. Air and oxygen may be mixed at an oxygen/air blender 770 to provide an oxygen-rich blended gas for inhalation by an infant. The oxygen richness of the blended gas may be made adjustable from approximately 20.8% to 100% oxygen. The blended gas then flows to a flow control unit 772, which regulates the volume of gas flowing from the resuscitation base unit 628. In the exemplary embodiment shown, the flow may be regulated from 0 to 15 liters per minute. The resuscitation base unit 628 may also be adapted to provide suction, such as to remove meconium fluid buildup from an infant's lungs. The suction may be developed through a suction generator 774, which may be a venturi-type suction generator that is driven by the oxygen supply. Suction may be controlled by a suction monitor 776, which can regulate the vacuum applied to a suction wand 778 (or catheter, not shown). Solids, liquids or other particulates that are picked up by the suction wand 778 (or catheter) may be deposited in a suction collection bottle 780, while spent gas may be ejected from the resuscitation base unit 628 through a suction exhaust 782. The resuscitation device 632 may also include internal controls for metering the flow of blended gas therethrough. For example, gas flowing into the handheld resuscitation device 632 may be monitored for airway pressure and flow timing at an airway pressure and timing sensor (APTS) 784. Downstream from the APTS 784, a pressure control 786 may be disposed for adjusting the PEEP levels and, in an instance where the resuscitation device 632 is used for CPAP, the CPAP pressures. In the exemplary embodiment described, the CPAP/PEEP range may be from 0 to 18 cm H₂O. An airway pressure monitor 788 and an adjustable pressure limiting device 790 may be disposed downstream from the pressure control 786 for controlling the PIP of the flow through the resuscitation device 632. The pressure control 786, airway pressure monitor 788 and adjustable pressure limiting device 790 may work in connection with a redundant pressure control 792, located on the resuscitation base unit 628, to ensure that the pressure of gas provided to an infant is not above predetermined levels. Gas flowing through the resuscitation device 632 may be discharged to a “T” piece end cap 794 (or other equivalent means), which leads to the breathing air port 654 described above with reference to FIG. 8. Immediately prior to flowing through the “T” piece end cap 794, the gas may be measured by an FiO₂ sensor 796 which provides feedback to the oxygen/air blender 770 to ensure a desirable level of oxygen is provided in the inspiratory gas. Alternatively, the FiO₂ sensor 796 may be provided on the base unit 628. Also as mentioned above, the resuscitation device 632 may be provided with a manual breath trigger 658 for restarting the breath timing. Sensed parameters, such as breaths per minute and time of inspiration may be displayed on the resuscitation device 632, using the display screen 652.

Referring again to FIG. 3, the control system 100 includes a control circuit 110, a light device 150, and a sound device 170. As will be understood by those of ordinary skill in the art, the control circuit 110 may comprise a general purpose or application-specific microprocessor, which includes at least two input ports, and at least one output port, as explained further below. The control circuit 110 may be adapted to receive at least two input signals in the form of a breath rate frequency signal 111 and a inspiration/expiration ratio signal 112 on the at least two input ports (i.e., the breath rate frequency signal 111 may be coupled to a first input port, and the inspiration/expiration ratio signal 112 may be coupled to a second input port). The values for breath rate frequency and inspiration/expiration ratio are preferably set by an operator (e.g., health care worker) prior to initiating resuscitation. Additionally, these values may be adjusted during resuscitation by the operator. These values may be selected using any of a variety of control means known to those of ordinary skill in the art, including but not limited to knobs, buttons, touch screens, softkeys, fingerwheels, etc. Whatever the control means, a signal is provided to the control circuit 110 in the form of a breath rate frequency signal 111 and a inspiration/expiration ratio signal 112.

The control circuit 110 outputs at least one device control signal 113 (on the at least one output port of the control circuit 110), which may be used to control the light device 150, the sound device 170, or both. The light device 150 may comprise a Light-Emitting Diode (LED), or any other equivalent device known to those of ordinary skill in the art. The sound device 170 may comprise a speaker, or any other equivalent device known to those of ordinary skill in the art.

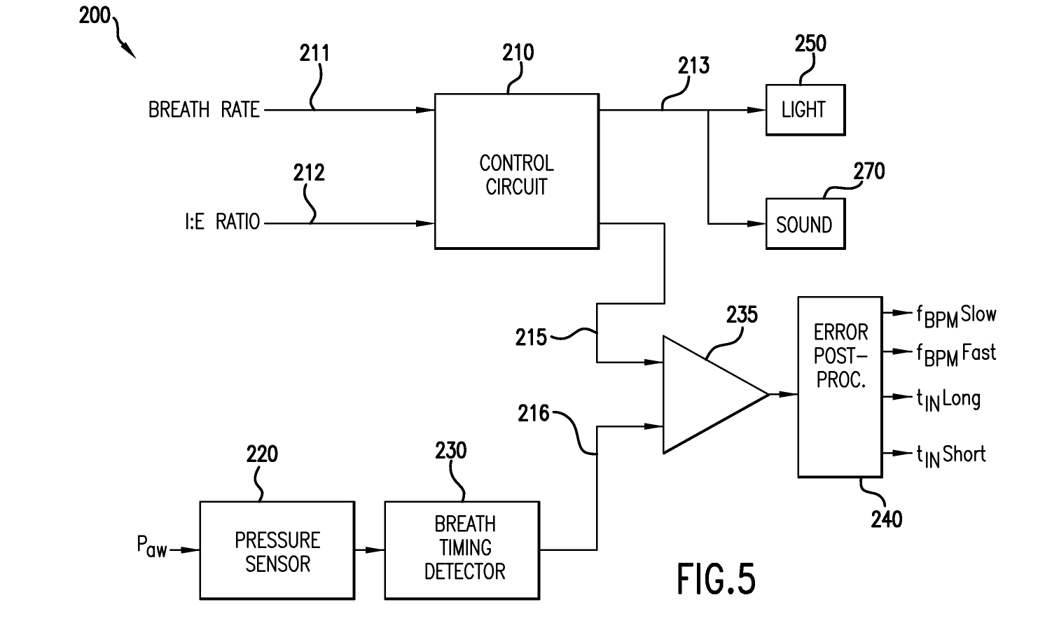

The device control signal 113 may take the form of a square wave logic signal which has a total time interval t_{TOTAL}, and which has an inspiration time interval t_{IN} and an expiration time interval t_{EX}, as shown in FIG. 4. The respiration frequency of the patient (f_{BPM}) in beats per minute (BPM) may be determined according to the following formula:

f_{BPM}=60/t_{TOTAL} (where t_{TOTAL} is in seconds)

In operation, one or both of the light device 150 and the sound device 170 indicate the inspiration and expiration periods of a resuscitation procedure. For example, the light device 150 may be active (i.e., lit) during inspiration, and inactive (i.e., extinguished) during expiration. The light and sound devices thereby assist a health care worker in administering resuscitation, by indicating to the health care worker when to deliver the inspiratory portion of the resuscitation procedure, and when to let the patient expire. The resuscitation control system 100 thus assists health care workers (especially those who are less experienced at resuscitation) in performing manual resuscitations. The resuscitation control system 100 can be particularly useful in infant resuscitation, where precision is critical.

FIG. 5 shows a block diagram of a resuscitation control system 200 according to a second exemplary embodiment of the present invention. The resuscitation control system 200 according to a second exemplary embodiment is similar to the resuscitation control system 100 of the first exemplary embodiment, and like reference numerals denote like elements. In the exemplary embodiment, the resuscitation control system 200 may be formed as part of the warming therapy device 10, or may be formed as a separate unit for use with the warming therapy device 10. For example, the resuscitation control system 200 may be formed as part of a resuscitation assembly, which may also include one or more ventilation hoses and a ventilation mask. As will be understood by those of ordinary skill in the art, the ventilation hoses of such a resuscitation assembly may be coupled to a source of oxygen, ambient air, or an air/oxygen mixture through, for example, interconnection nozzles 51 of the backplane 50 of the warming therapy device 10. Alternatively, the resuscitation control system 200 may be formed as part of a separate resuscitation assembly, also including one or more ventilation hoses and a ventilation mask, which is not directly coupled to a warming therapy device.

The control system 200 includes a control circuit 210, a light device 250, and a sound device 270. As will be understood by those of ordinary skill in the art, the control circuit 210 may comprise a general purpose or application-specific microprocessor, which includes at least two input ports, and at least two output ports, as explained further below. The control circuit 210 receives at least two input signals in the form of a breath rate frequency signal 211 and a inspiration/expiration ratio signal 212. The control circuit 210 outputs at least one device control signal 213, which may be used to control the light device 250, the sound device 270, or both, and at least one monitor signal 215. The control system 200 also includes a pressure sensor 220, a breath timing detector 230, a signal comparator 235, and an error post-processing circuit 240, which together form a pressure monitoring system. The light device 250 may comprise a Light-Emitting Diode (LED), or any other equivalent device known to those of ordinary skill in the art. The sound device 270 may comprise a speaker, or any other equivalent device known to those of ordinary skill in the art.

In operation, one or both of the light device 250 and the sound device 270 indicate the inspiration and expiration periods of a resuscitation procedure. For example, the light device 250 may be active (i.e., lit) during inspiration, and inactive (i.e., extinguished) during expiration. As noted above, the light and sound devices operate to assist a health care worker in administering resuscitation, by indicating to the health care worker when to deliver the inspiratory portion of the resuscitation procedure, and when to let the patient expire. Again, the resuscitation control system 200 can be particularly useful in infant resuscitation, where precision is critical.

The control system 200 also operates to monitor certain conditions, such as patient airway pressure (P_{AW}), and breathing time through the pressure sensor 220 and the breath timing detector 230, respectively. Patient airway pressure (P_{AW}) comprises the patient airway pressure at a given moment in time (as opposed to PIP which comprises the maximum pressure during a breath). The pressure sensor 220 and the breath timing detector 230 together produce an output signal 216 which is compared to the monitor signal 215 in the signal comparator 235. Where the output signal 216 and the monitor signal 215 are analog voltage values, the voltages are compared in the signal comparator 235. Alternatively, where the output signal 216 and the monitor signal 215 are digital values, the digital values (typically binary values comprised of 1s and 0s) are compared in the signal comparator 235. The pressure sensor 220 and the breath timing detector 230 may comprise any sensors known to those of ordinary skill in the art. In one exemplary embodiment, an output signal of the pressure sensor 220 may be analyzed using a microcontroller with a smart algorithm (not shown), which utilizes information from the previous breath to determine the beginning of inspiration, and the beginning of expiration from dynamically established pressure thresholds, and then calculates the elapsed time of each phase. Once the phase times are determined, the frequency in breaths per minute and inspiration/expiration ratio can be calculated.

The signal comparator 235 produces an output signal which is fed to the error post-processing circuit 240, which in turn outputs an error signal. For example, the voltage value at the output of the signal comparator 235 may indicate which of several error types have been encountered; if the voltage is too high, it may indicate that the inspiration time (t_{IN}) is too long. Four exemplary error signals are shown in FIG. 5, including: (1) breath rate (f_{BPM}) too slow, (2) breath rate too fast, (3) inspiration time (t_{IN}) too long, and (4) inspiration time too short. Those of ordinary skill in the art will realize that these are only exemplary errors, and various other errors can be detected and indicated using the control system 200. The error signals may be utilized to provide additional indications to the operator during resuscitation, so that corrections can be made. For example, one or more of the error signals may be coupled to one or more of the light device 250 and the sound device 270, in order to provide indications to the operator. The error signal indicating that the inspiration time (t_{IN}) is too long could be coupled, for example, to the light device 250 in a manner to cause the color of the light device to change when the inspiration time (t_{IN}) is too long. In this manner, the light device 250 can be used to inform the operator of the inspiration time (t_{IN}), and also of errors associated with the same. In other words, if the operator is not matching the preset ventilation timing set by the control circuit 210, the light device will indicate as much to the operator by changing the color of the light, from green to red, for example. Those of ordinary skill in the art will realize that the sound device 270 may also be used for indicating errors, or some combination of the light and sound devices 250, 270. Those of ordinary skill in the art will also realize that it is not necessary to use the light device 250 and/or the sound device 270 for indicating errors, and alternative means may be provided for such a purpose (e.g., additional light devices, additional sound devices, etc.).

Although the control system 200 described above is discussed as including a pressure sensor 220, those of ordinary skill in the art will realize that various other sensors may be used in place of the pressure sensor to detect breathing timing. For example, airflow sensors and chest impedance sensors can be used for this purpose.

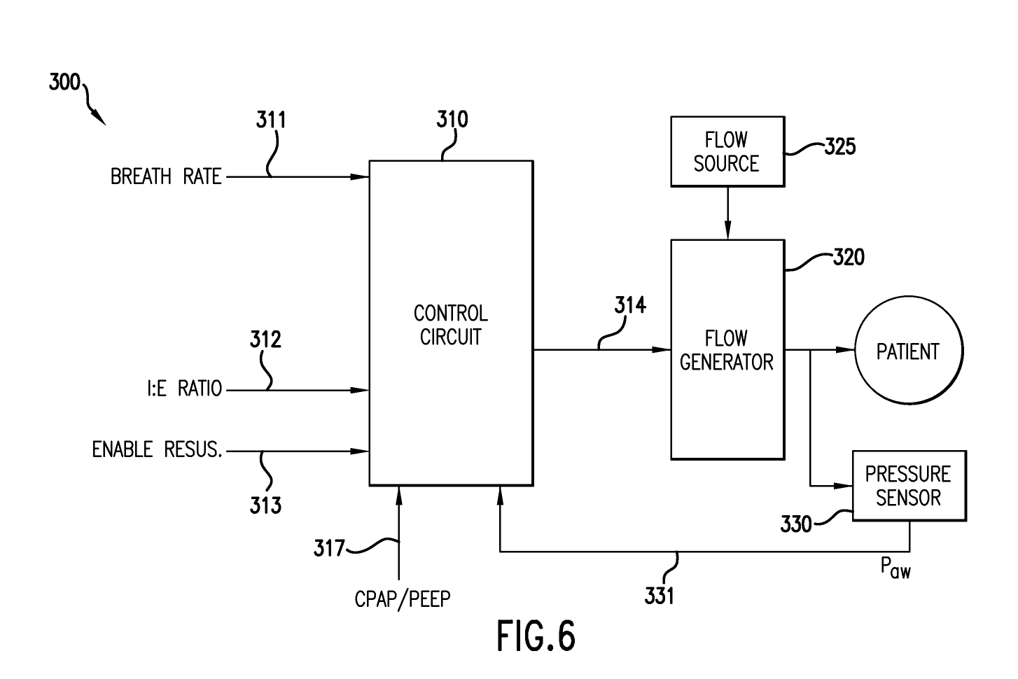

FIG. 6 shows a block diagram of a resuscitation control system 300 according to a third exemplary embodiment of the present invention. In the exemplary embodiment, the resuscitation control system 300 may be formed as part of the warming therapy device 10, or may be formed as a separate unit for use with the warming therapy device 10. For example, the resuscitation control system 300 may be formed as part of a resuscitation assembly, which may also include one or more ventilation hoses and a ventilation mask. As will be understood by those of ordinary skill in the art, the ventilation hoses of such a resuscitation assembly may be coupled to a source of oxygen, ambient air, or an air/oxygen mixture through, for example, interconnection nozzles 51 of the backplane 50 of the warming therapy device 10. Alternatively, the resuscitation control system 300 may be formed as part of a separate resuscitation assembly, also including one or more ventilation hoses and a ventilation mask, which is not directly coupled to a warming therapy device.

The control system 300 includes a control circuit 310, a flow generator 320, and a flow source 325. As will be understood by those of ordinary skill in the art, the control circuit 310 may comprise a general purpose or application-specific microprocessor, which includes at least five input ports, and at least one output port, as explained further below. The flow source 325 may comprise any positive pressure flow generating device such as, for example, a blower, wall supply pressures, Air, Oxygen, Air and Oxygen mixture, or the like. For example, the flow source may comprise a ventilation hose and mask coupled to one or more of the interconnection nozzles 51 of the backplane 50 of the warming therapy device 10. The control circuit 310 receives at least four input signals in the form of a breath rate frequency signal 311, an inspiration/expiration ratio signal 312, a resuscitation enable signal 313, and a Continuous Positive Airway Pressure/Positive End Expiratory Pressure (CPAP/PEEP) signal 317. The control circuit 310 outputs at least one device control signal 314, which may be used to control the flow generator 320. The control system 300 further comprises a pressure sensor 330. The pressure sensor 330 is coupled to the output of the flow generator 320 and measures the patient airway pressure (P_{AW}) of the gas delivered to the patient by the flow generator 320. The pressure sensor 330 provides the measured value of the P_{AW} as output signal 331, which is in turn provided as an input to the control circuit 310, thus providing feedback of the delivered pressure to the control circuit 320. This feedback is utilized by the control circuit 320 to adjust the device control signal 314 according to the value of the input CPAP/PEEP signal 317.

In operation, the control circuit 310 produces a device control signal 314 which is selectively supplied to the flow generator 320 via the resuscitation enable signal 313 (when active). For example, the control system may include a button, switch or other equivalent activation means (not shown) which is controlled by an operator. The button or other means, when depressed by the operator, may be configured to provide a device control signal 314 to the flow generator 320 indicating that flow should initiate. This would, in turn, permit flow of oxygen or other gas stored in the flow source 325 to the patient. For safety, the button or other means providing the resuscitation enable signal 313 may be configured to deactivate when pressure is removed therefrom. In other words, the button or other means may be configured such that the operator must continuously depress the button in order to keep the flow generator 320 enabled. This effectively prevents the operator from leaving the patient's area during resuscitation. However, it should also be noted that the device control signal 314 is also controlled by the breath rate frequency signal 311 and the inspiration/expiration ratio signal 312, such that no flow will be provided from the flow generator 320 to the patient when the control circuit 310 is in an expiration cycle (i.e., during time t_{EX}, as shown in FIG. 4).

The control system 300 assists the health care worker in administering resuscitation, by providing an automated delivery of the inspiratory and expiratory portions of the resuscitation procedure. The resuscitation control system 300 thus assists health care workers (especially those who are less experienced at resuscitation) in performing manual resuscitations. The resuscitation control system 300 can be particularly useful in infant resuscitation, where precision is critical.

Those of ordinary skill in the art will realize that although the control systems 100, 200 and 300 described above are discussed in connection with a warming therapy device, the exemplary embodiments of the present invention are not so limited. For example, the control systems 100, 200 and 300 may be used in connection with any device or system for providing resuscitation. The control systems 100, 200, and 300 are useful in all applications where manual resuscitation is performed using ‘breathing bags,’ “T piece” resuscitators, or any other equivalent resuscitation device, whether performed on adults or infants. For example, the control systems 100, 200, and 300 may be used in the field by an emergency care rescue team.

Further, although exemplary embodiments of the present invention have been described above for use in procedures involving infant patients, those of ordinary skill in the art will realize that the warming therapy device 10, and control systems 100, 200, 300, according to the exemplary embodiments of the present invention, may be used for other types of operations and procedures, including for children and adults without departing from the scope of the present invention.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus comprising:
a patient support assembly; and,
a resuscitation assembly including a resuscitation control system which includes a resuscitation control circuit, a light device, and a sound device,
wherein the light device may be activated by the resuscitation control circuit to provide a visual indication of inspiration and expiration periods of a resuscitation procedure.

2. The apparatus of claim 1, further comprising a mattress tray assembly coupled to the patient support assembly.

3. The apparatus of claim 1, wherein the resuscitation control circuit includes a breath rate frequency input port, and a inspiration/expiration ratio input port.

4. The apparatus of claim 1, wherein the resuscitation control circuit includes at least one output port coupled to one or more of the light device and the sound device.

5. The apparatus of claim 1, wherein the sound device may be activated by the resuscitation control circuit to provide an audio indication of inspiration and expiration periods of a resuscitation procedure.

6. The apparatus of claim 1, wherein the light device is lit during an inspiration period, and extinguished during an expiration period.

7. The apparatus of claim 3, wherein the resuscitation control circuit includes first and second output ports, the first output port coupled to one or more of the light device and sound device, and the second output port coupled to a pressure monitoring system.

8. The apparatus of claim 7, wherein the pressure monitoring system comprises:
a signal comparator;
an error processing circuit; and,
a pressure sensor coupled to the signal comparator.

9. The apparatus of claim 7, wherein the pressure monitoring system is coupled to the light device, and wherein the pressure monitoring system produces a first error signal which may be used to alter the color of light produced by the light device.

10. The apparatus of claim 7, wherein the pressure monitoring system is coupled to the sound device, and wherein the pressure monitoring system produces a first error signal which may be used to alter the sound produced by the sound device.

11. The apparatus of claim 9, wherein the color of light changes from green to red when the first error signal indicates an error.

12. The apparatus of claim 1, further comprising:
a flow source; and,
a flow generator coupled to the flow source and the resuscitation control circuit.

13. The apparatus of claim 1, wherein the resuscitation assembly further comprises:
at least one ventilation line; and,
a resuscitation mask coupled to the at least one ventilation line.

14. The apparatus of claim 1, wherein the resuscitation assembly further comprises:
at least one ventilation line; and,
a hand-held resuscitation device coupled to the at least one ventilation line.

15. The apparatus of claim 14, wherein the hand-held resuscitation device further comprises:
an ergonomic handle;
a mouth and nose piece;
a control pad; and,
a display screen.

16. The apparatus of claim 14, wherein the resuscitation assembly further comprises a resuscitation base station which may be coupled to the hand-held resuscitation device.

17. The apparatus of claim 14, wherein the resuscitation assembly further comprises a manual breath trigger for controlling an automatically-timed breathing cycle.

18. The apparatus of claim 15, wherein the mouth and nose piece comprises:
a mouthpiece; and,
a manifold including at least one nasal prong.

19. An apparatus comprising:
a resuscitation control circuit;
a light device; and,
a sound device;
wherein the resuscitation control circuit receives first and second control signals, and outputs a third control signal for activating or deactivating the light device.

20. The apparatus of claim 19, wherein activation of the light device indicates an inspiration period of a resuscitation procedure, and deactivation of the light device indicates an expiration period of a resuscitation procedure.

21. The apparatus of claim 19, further comprising a pressure monitoring system for measuring the airway pressure of a patient.

22. A method of providing resuscitation to a patient, the method comprising:
performing resuscitation on a patient;
observing the condition of a light device during the performance of the resuscitation;
performing an inspiration step of the resuscitation when the light device is lit; and
performing an expiration step of the resuscitation when the light device is extinguished.

23. The method of claim 22, comprising the further steps of:
observing the condition of a sound device during the performance of the resuscitation;
performing an inspiration step of the resuscitation when sound emanates from the sound device; and
performing an expiration step of the resuscitation when sound does not emanate from the sound device.

24. The method of claim 22, comprising the further steps of:
observing the condition of the light device during the performance of the resuscitation; and,
changing a first parameter of the resuscitation if the light device changes color.

25. The method of claim 24, wherein the first parameter is selected from the group consisting of: inspiration time and breath rate.

26. A hand-held resuscitation device comprising:
a handle;
a mouth and nose piece;
a control pad; and,
a display screen.

27. The hand-held resuscitation device of claim 26, wherein the mouth and nose piece comprises:
a mouthpiece; and,
a manifold including at least one nasal prong.
